(19) United States
(12) Patent Application Publication
(10) Pub. No.: US 2016/0165213 A1
(43) Pub. Date: Jun. 9, 2016

(54) LAYERED TYPE COLOR-DEPTH SENSOR AND THREE-DIMENSIONAL IMAGE ACQUISITION APPARATUS EMPLOYING THE SAME

(71) Applicant: SAMSUNG ELECTRONICS CO., LTD., Suwon-si (KR)

(72) Inventors: Hongseok LEE, Seongnam-si (KR); Kyusik KIM, Yongin-si (KR); Jungwoo KIM, Hwaseong-si (KR); Dokyoon KIM, Seongnam-si (KR)

(73) Assignee: SAMSUNG ELECTRONICS CO., LTD., Suwon-si (KR)

(21) Appl. No.: 14/899,677

(22) PCT Filed: May 27, 2014
(86) PCT No.: PCT/KR2014/004698

§ 371 Date: Dec. 18, 2015

(30) Foreign Application Priority Data
Jun. 19, 2013 (KR) 10-2013-0070491

(51) Int. Cl. H04N 13/02; H04N 9/04

(52) U.S. Cl. CPC H04N 13/0253; H04N 9/045; H04N 13/0207; H04N 13/0271; H04N 2209/047

(57) ABSTRACT

Provided are a color-depth sensor and a three-dimensional image acquisition apparatus including the same. The color-depth sensor includes a color sensor that senses visible light and an infrared sensor that is stacked on the color sensor and senses infrared light. The 3D image acquisition apparatus includes: an imaging lens unit; a color-depth sensor that simultaneously senses color image information and depth image information about an object from light reflected by the object and transmitted through the imaging lens unit; and a 3D image processor that generates 3D image information by using the color image information and the depth image information sensed by the color-depth sensor.

### TECHNICAL FIELD

This application claims priority from Korean Patent Application No. 10-2013-0070491, filed on Jun. 19, 2013, in the Korean Intellectual Property Office, the disclosure of which is incorporated herein in its entirety by reference.

Apparatuses consistent with exemplary embodiments relate to sensors for simultaneously sensing color and depth and three-dimensional (3D) image acquisition apparatuses employing the sensors.

### BACKGROUND ART

Imaging optical devices such as digital cameras employing solid-state imaging devices such as a charge-coupled device (CCD) or complementary metal-oxide-semiconductor (CMOS) imaging devices have rapidly gained popularity in recent years.

Furthermore, with the advancement and increasing demand for three dimensional (3D) displays, 3D content has become of paramount importance, and research has been actively carried out on 3D cameras that allow general users to directly create 3D content. Such 3D cameras are able to measure 3D image information as well as measuring two dimensional (2D) red, green, and blue (RGB) color image information. Techniques for measuring 3D image information are mainly classified as stereoscopic techniques or depth measurement techniques. In the stereoscopic technique, two lenses and two sensors are used to measure left and right eye images that are processed in the human brain to give a sense of depth. In the depth measurement technique, 3D distance information is directly measured by using a triangulation method or Time-of-Flight (TOF) measurement.

Structures for measuring 3D image information by using the depth measurement technique are divided into three main categories: two-lens two-sensor structures, one-lens two-sensor structures, and one-lens one-sensor structures. Among these, the one-lens one-sensor structure using a single lens and a single sensor has the smallest volume and lowest price. However, when this structure is used, inconsistency between a depth image and a color image may occur when taking a picture of a fast-moving object since the sensor receives visible light and infrared light in a time-multiplexing manner. Furthermore, this structure requires an additional device for time multiplexing. To solve these problems, the sensor may be divided into regions for visible light and infrared light, which may degrade the image resolution.

### DISCLOSURE OF INVENTION

### Technical Problem

One or more exemplary embodiments provide may color-depth sensors for obtaining depth image information and color image information without time lag therebetween and 3D image acquisition apparatuses employing the color-depth sensors.

### Solution to Problem

Additional exemplary aspects will be set forth in part in the description which follows and, in part, will be apparent from the description, or may be learned by practice of the presented embodiments.

According to an aspect of an exemplary embodiment, a color-depth sensor includes a color sensor that senses visible light and an infrared sensor that is stacked on the color sensor and senses infrared light.

The infrared sensor may include a photoelectric conversion layer made of an organic semiconductor material that absorbs the infrared light.

The photoelectric conversion layer may include a tin phthalocyanine (SnPc): C₆₀ layer, a mixture of squaraine dye and Phenyl-C61-Butyric-Acid-Methyl-Ester (PCBM), or a poly_3-hexylthiophene (P3HT):PCBM layer.

The photoelectric conversion layer may have a thickness appropriate for creating a resonant cavity structure that is capable of resonating infrared light having a predetermined wavelength.

The color-depth sensor may further include an infrared cut-off filter that is disposed on a path of light having passed through the infrared sensor for blocking infrared light =.

The color-depth sensor may further include a bandpass filter that is disposed on the infrared sensor to transmit infrared light and visible light.

The color-depth sensor may further include a terahertz sensor that is disposed on the infrared sensor.

According to an aspect of another exemplary embodiment, a 3D image acquisition apparatus includes: an imaging lens unit; a color-depth sensor that simultaneously senses color image information and depth image information about an object from light reflected by the object and transmitted through the imaging lens unit; and a 3D image processor that generates 3D image information by using the color image information and the depth image information sensed by the color-depth sensor.

The infrared sensor may include a photoelectric conversion layer made of an organic semiconductor material that absorbs infrared light.

The color-depth sensor may further include an infrared cut-off that is disposed on a path of light having passed through the infrared sensor for blocking of infrared light.

The color-depth sensor may further include a terahertz sensor that is disposed on an optical path toward the infrared sensor.

The apparatus may further include a bandpass filter that transmits infrared light and visible light.

The bandpass filter may be disposed between the object and the imaging lens unit.

The bandpass filter may be disposed on a surface of a lens of the imaging lens unit, the surface facing the object.

The bandpass filter may be disposed on a light entrance surface of the color-depth sensor.

The apparatus may further include a lighting unit that emits light toward the object.

The lighting unit may include a light-emitting diode (LED) or a laser diode (LD) that emits infrared.

According to an aspect of another exemplary embodiment, a 3D image acquisition apparatus includes: a lighting unit emitting a terahertz wave and infrared light toward an object; a sensor unit having an infrared sensor and a terahertz sensor stacked together to simultaneously sense terahertz wave and the infrared light transmitted through or reflected by the object; and a 3D image processor that generates a terahertz image and a depth image by using the terahertz wave and the infrared light sensed by the terahertz sensor and the infrared sensor, respectively, and creates 3D image information by using the terahertz image and the depth image.

### Advantageous Effects of Invention

According to the one or more of the above-described exemplary embodiments, a layered type color-depth sensor may measure without a time lag color image information and depth image information about an object.

The layered type color-depth sensor may further include a terahertz sensor in order to measure terahertz image information in addition to the color image information and the depth image information.

The layered type color-depth sensor may also be used in a 3D image acquisition apparatus to obtain color image information and depth image information about the object on the same optical path, thereby eliminating the need for a structure for separating a light beam carrying color image information from a light beam carrying depth image information and simplifying the structure of an optical system.

The presence of the layered type color-depth sensor eliminates the need to sense color image information and depth image information in a time-multiplexing manner, so that there is little time difference between sensing a color image and a depth image. Thus, the measurement time is increased, thereby improving the measurement efficiency and facilitating creation of a 3D moving image.

### BRIEF DESCRIPTION OF DRAWINGS

These and/or other exemplary aspects and advantages will become apparent and more readily appreciated from the following description of exemplary embodiments, taken in conjunction with the accompanying drawings in which:

FIG. 1 is a schematic diagram of a color-depth sensor according to an exemplary embodiment;

FIGS. 2A, 2B and 2C are cross-sectional views illustrating exemplary structures of an infrared sensor used in the color-depth sensor of FIG. 1;

FIG. 3 is a schematic diagram of a color-depth sensor according to another exemplary embodiment;

FIG. 4 is a schematic diagram of a color-depth sensor according to another exemplary embodiment;

FIGS. 5A, 5B, and 5C illustrate transmission spectra when light incident on the color-depth sensor of FIG. 4 passes through a band pass filter, an infrared sensor, and a color sensor, respectively;

FIG. 6 is a schematic diagram of a color-depth sensor according to another exemplary embodiment of the present invention;

FIG. 7 is a schematic block diagram of a 3D image acquisition apparatus according to an exemplary embodiment; and

FIG. 8 is a schematic block diagram of a 3D image acquisition apparatus according to another exemplary embodiment.

### MODE FOR THE INVENTION

Color-depth sensors and 3D image acquisition apparatuses according to exemplary embodiments will now be described more fully hereinafter with reference to the accompanying drawing, wherein like reference numerals refer to the like elements throughout. Sizes of layers, regions and/or other elements may be exaggerated for clarity and convenience of explanation. The present embodiments may have different forms and should not be construed as being limited to the descriptions set forth herein. It will be understood that when an element is referred to as being “on” or “over” another element, it can be directly on the other element or intervening elements may also be present.

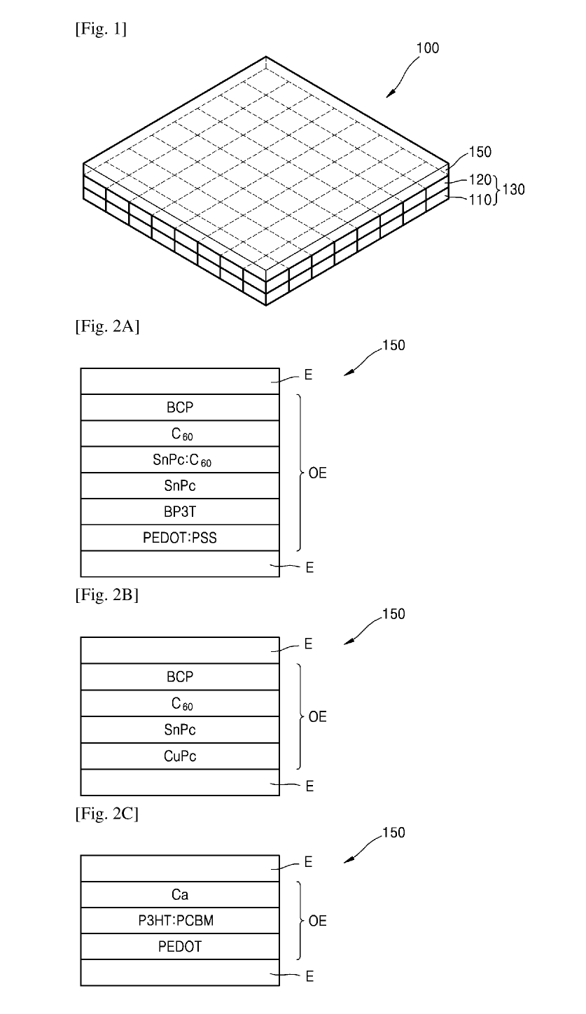

FIG. 1 is a schematic diagram of a color-depth sensor 100 according to an exemplary embodiment. The color-depth sensor 100 according to the present embodiment includes a color sensor 130 for sensing light in a visible region and an infrared sensor 150 stacked on the color sensor 130 to sense light in an infrared region.

The color sensor 130 is used to acquire color information about an object and includes a sensor layer 110 that senses light corresponding to an image of the object and converts the light into an electrical signal. The sensor layer 110 may include a Charge Coupled Device (CCD) or a Complementary Metal-Oxide Semiconductor (CMOS) device. The color sensor 130 further includes a color filter array layer 120 in which four red (R), green (G), green (G), and blue (B) subpixels form one pixel P; however, this embodiment is not limited to such an arrangement of subpixels.

The infrared sensor 150 is used to acquire depth information about an object and includes a photoelectric conversion layer that senses light in the infrared region and converts the light into an electrical signal. The photoelectric conversion layer may include various types of organic and inorganic materials.

Although not shown, like the color sensor 130, the infrared sensor 150 may be partitioned into a plurality of regions so as to achieve a resolution suitable for displaying a depth image. In this case, the infrared sensor 150 does not necessarily have the same resolution as the color sensor 130, and may have a lower resolution than the color sensor 130.

Although the color filter array layer 120 is shown as disposed between the infrared sensor 150 and the sensor layer 110, the infrared sensor 150 may be located between the color filter array layer 120 and the sensor layer 110.

The color-depth sensor 100, according to the present embodiment, is adapted to obtain color information and depth information of incident light along the same optical path, with little time lag. Thus, selectivity is an important parameter in the infrared sensor 150, in order to enable the sensor to selectively absorb only light in the infrared region.

Recently, an organic semiconductor material for a photoelectric conversion layer has been developed. This organic semiconductor material has high selectivity to light in the infrared and near-infrared regions. The organic semiconductor material may be used in the infrared sensor 150.

FIGS. 2A through 2C are cross-sectional views illustrating exemplary structures of the infrared sensor 150 for use in the color-depth sensor 100 of FIG. 1.

Referring to FIGS. 2A through 2C, each of the infrared sensors 150 includes a photo-electric conversion layer OE and two electrodes E disposed at either side of the photo-electric conversion layer OE.

The photoelectric conversion layer OE may include tin phthalocyanine (SnPc), C₆₀, or a mixture of SnPc and C₆₀ in a predetermined ratio. Alternatively, the photoelectric conversion layer OE may include poly_3-hexylthiophene (P3HT), Phenyl-C61-Butyric-Acid-Methyl-Ester (PCBM), or a mixture thereof in a predetermined ratio. For another example, the photoelectric conversion layer OE may include bis-biphenyl-4-yl-terthiophene (BP3T), bathocuproine (BCP), Poly(3,4-Ethylenedioxythiophene) (PEDOT), poly(styrene sulphonate) (PEDPT-PSS), or squaraine dye. Each of the two electrodes E may be formed of a transparent electrode material such as indium tin oxide (ITO).

The photoelectric conversion layer OE shown in FIG. 2A may include a SnPc: C₆₀ layer. Referring to FIG. 2A, the photoelectric conversion layer OE includes a PEDOT:PSS layer, a BP3T layer, a SnPc layer, a SnPc:C₆₀layer, a C₆₀ layer, and a BCP layer.

In the SnPc: C₆₀ layer, a mixture ratio of SnPc and C₆₀ may be about 1:1 to about 1:5. As the percentage of SnPc increases, an absorption rate of the SnPc: C₆₀ layer increases at a wavelength near about 950 nm and decreases in a near infrared region around wavelengths of about 750 to about 800 nm. A wavelength band in which absorption occurs may vary depending on a thickness of the SnPc: C₆₀ layer and compositions and thicknesses of other layers as well as the content of SnPc. These factors may be adjusted to create an absorption spectrum having a peak value in a desired wavelength range.

Referring to FIG. 2B, the photoelectric conversion layer OE includes a copper phthalocyanine (CuPc) layer, a SnPc layer, a C₆₀ layer, and a BCP layer. By adjusting a thickness of each layer, an absorption spectrum having a peak value in a desired wavelength range may be created.

Referring to FIG. 2C, the photoelectric conversion layer OE includes a PEDOT layer, a poly_3-hexylthiophene (P3HT): Phenyl-C61-Butyric-Acid-Methyl-Ester (PCBM) layer, and a calcium (Ca) layer. The P3HT:PCBM layer may have a thickness of about 200 nm to about 14 um. The P3HT:PCBM layer is formed by annealing a mixture of P3HT and PCBM and has a sufficient thickness in the above range, thus having an increased absorption rate in a wavelength range of 750 nm to 950 nm.

In addition to the exemplary structures illustrated in FIGS. 2A through 2C, the photoelectric conversion layer may include a mixture of squaraine dye and PCBM. The squaraine dye may be AlkSQ or GlySQ, and an absorption spectrum may be formed in a near infrared region by appropriately adjusting a mixture ratio of the quaraine dye and PCBM.

An absorption bandwidth may be adjusted by forming periodic patterns or including nano materials in the above-described structures of the infrared sensor 150. For example, holes or bumps in nano/micro periodic structures may be further formed in the infrared sensor 150.

Furthermore, in the infrared sensor 150, a thickness of the photoelectric conversion layer OE may be determined so as to create a resonant cavity. More specifically, when the photoelectric conversion layer OE is made of a material that can absorb light in the infrared region, and its thickness is appropriately adjusted, constructive interference occurs among light rays in a predetermined wavelength range, thus further decreasing a bandwidth of an absorption wavelength band and increasing wavelength selectivity. The increased wavelength selectivity allows sufficient transmission of visible light through the infrared sensor 150.

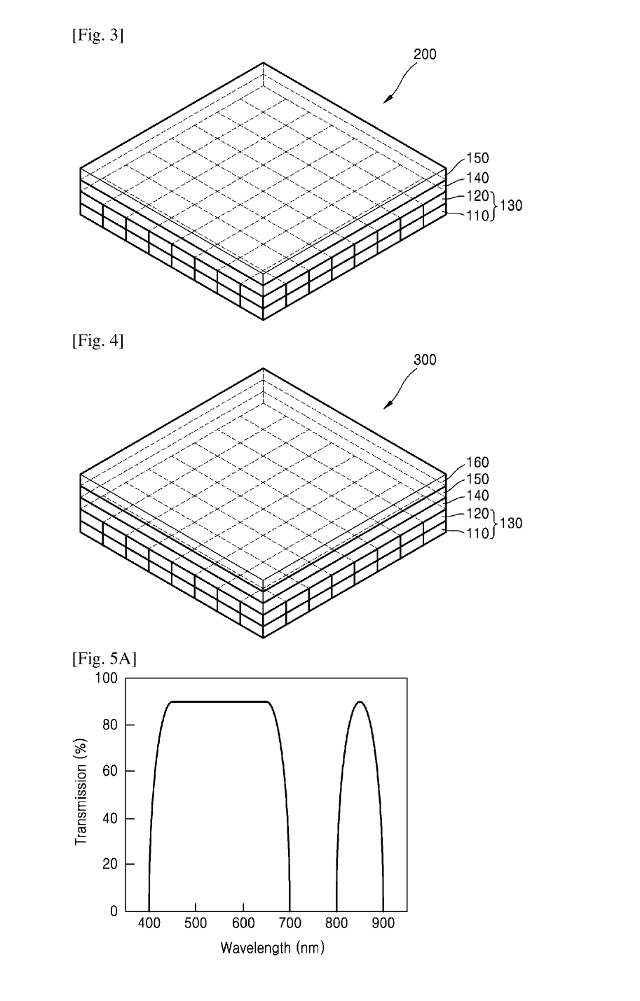

FIG. 3 is a schematic diagram of a color-depth sensor 200 according to another exemplary embodiment. Referring to FIG. 3, the color-depth sensor 200 according to the present embodiment is different from the color-depth sensor 100 of FIG. 1 in that it further includes an infrared cut-off filter 140 disposed between the infrared sensor 150 and the color sensor 130 for blocking of light in the infrared region.

The infrared cut-off filter 140 may be used when cut-off of infrared light is not sufficient after light passes through the infrared sensor 150. Namely, the infrared cut-off filter 140 is configured to prevent the infrared light that has passed through the infrared sensor 150 from reaching the color sensor 130, thereby reducing noise that may be generated in a color image. A band of cut-off wavelengths for the infrared cut-off filter 140 may be determined in consideration of an absorption spectrum of the infrared sensor 150.

FIG. 4 is a schematic diagram of a color-depth sensor 300 according to another exemplary embodiment.

The color-depth sensor 300 according to the present embodiment is different from the color-depth sensor 200 of FIG. 3 in that the color-depth sensor 300 further includes a bandpass filter 160 disposed on the infrared sensor 150. The bandpass filter 160 is configured to transmit only light in the infrared region and the visible region among incident light. FIGS. 5A through 5C illustrate transmission spectra when light incident on the color-depth sensor 300 of FIG. 4 passes through the band pass filter 160, the infrared sensor 150, and the color sensor 130, respectively.

Referring to FIG. 5A, light in the infrared region and visible region is transmitted by the bandpass filter 160. Referring to FIG. 5B, light in the infrared region is absorbed by the infrared sensor 150. After passing through the band pass filter 160 and the infrared sensor 150, light is incident on the color sensor 130 in a form as shown in FIG. 5C. The light having different wavelengths corresponding to three colors R, G, and B passes through corresponding R, G, and B regions in the color filter array layer 120 and is then absorbed in the sensor layer 110.

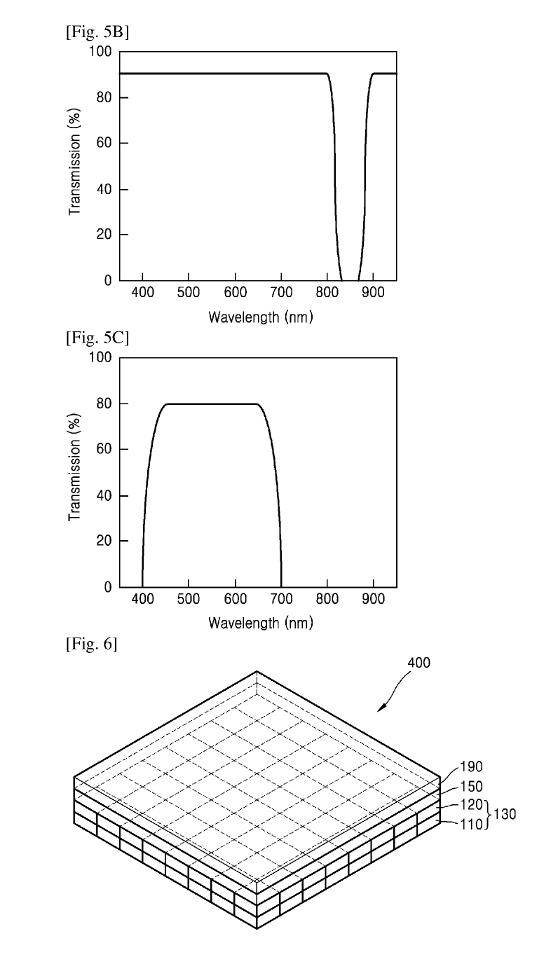

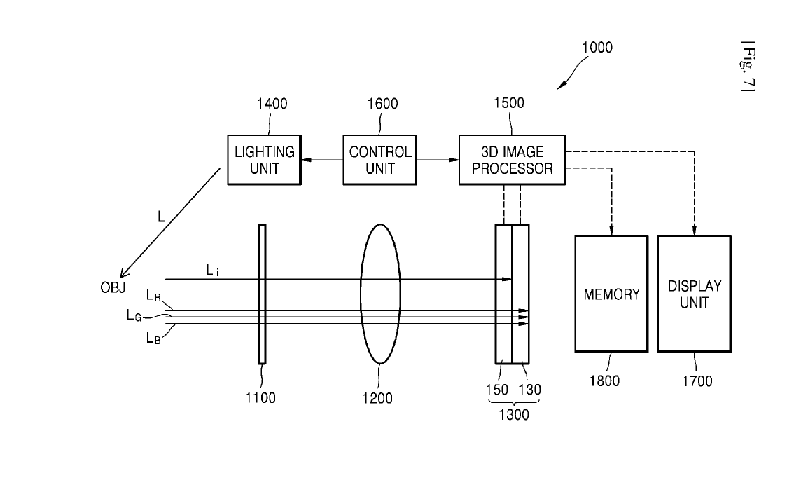

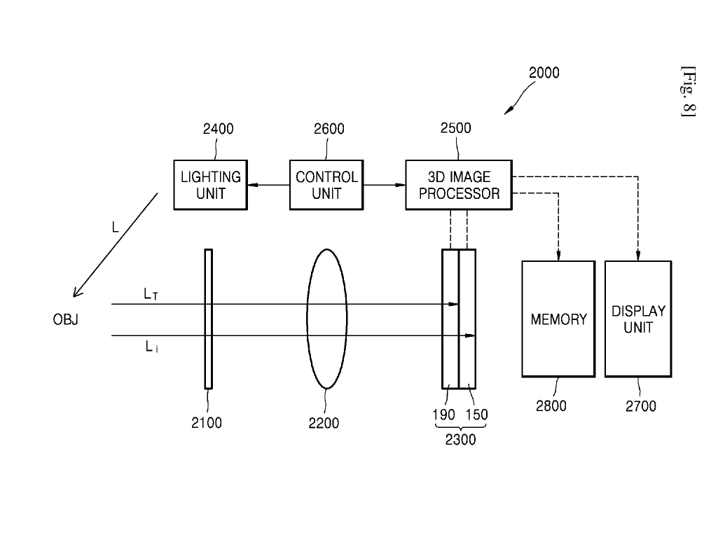

FIG. 6 is a schematic diagram of a color-depth sensor 400 according to another exemplary embodiment.

Referring to FIG. 6, the color-depth sensor 400 includes a color sensor 130, an infrared sensor 150, and a terahertz sensor 190. The terahertz sensor 190 detects terahertz waves used to create projection images of an object and analyze material compositions of the object. The color-depth sensor 400 may further include an infrared cut-off filter as illustrated in FIGS. 3 and 4, which is disposed between the infrared sensor 150 and the color sensor 130. The color-depth sensor 400 may further include a bandpass filter that is disposed on the terahertz sensor 190 and transmits light in the terahertz region, the infrared region, and the visible region.

FIG. 7 is a schematic block diagram of a 3D image acquisition apparatus 1000 according to an exemplary embodiment.

The 3D image acquisition apparatus 1000 according to the present embodiment includes an imaging lens unit 1200 that forms an image of an object OBJ, a color-depth sensor 1300 that senses color image information and depth image information about the object OBJ from light reflected by the object OBJ and transmitted through the imaging lens unit 1200, and a 3D image processor 1500 that generates 3D image information by using the color image information and the depth image information sensed by the color-depth sensor 1300.

The 3D image acquisition apparatus 1000 further includes a lighting unit 1400 that emits light toward the object OBJ, a control unit 1600 that controls operations of the 3D image processor 1400 and the lighting unit 1400, a display unit 1700 that displays a 3D image produced by the 3D image processor 1500, and a memory 1800 that stores 3D image data output from the 3D image processor 1500.

The color-depth sensor 1300 includes a color sensor 130 for sensing light in a visible region and an infrared sensor 150 forming a stacked structure with the color sensor 130 and sensing light in an infrared region. The color-depth sensor 1300 is adapted to simultaneously sense the color image information and the depth image information. The term “simultaneously” does not mean that the color image information and the depth image information are sensed at precisely the same time, and it means that the color image information and the depth image information can be sensed separately from each other without time multiplexing.

The color-depth sensors 100, 200, 300, and 400 having the structures described with reference to FIGS. 1, 3, 4, and 6 may be used as the color-depth sensor 1300.

Although the infrared sensor 150 is disposed on the color sensor 130, this is only an example. As described above, the color sensor 130 may include a color filter array layer and a sensor layer, and the infrared sensor 150 may be interposed between the color filter array layer and the sensor layer.

Light beams from the object OBJ, i.e., color light beams LR, LG, and LB carrying color image information and infrared light Li carrying depth image information, are incident on the color-depth sensor 1300 having the above-described structure along the same optical path. Thus, use of a beam splitter that is conventionally provided for separating color light beams from infrared light is not necessary, thereby simplifying a structure of an optical system. Furthermore, the color-depth sensor 1300 is configured to separate and sense the color light beams LR, LG, and LB and the infrared light Li, thereby eliminating the need for driving in a time-multiplexing manner and further simplifying 3D image processing.

A bandpass filter 1100 may be located between the imaging lens unit 1200 and the object OBJ so as to transmit only light in the infrared region and the visible region. The bandpass filter 1100 may be disposed on a cover glass that is commonly provided in a camera. Alternatively, the bandpass filter 1100 may be disposed on a surface of a lens in the imaging lens unit 1200 that faces the object OBJ, or disposed at a light entrance surface of the color-depth sensor 1300, e.g., on the infrared sensor 150. The bandpass filter 1100 may be omitted.

The imaging lens unit 1200 forms an image of the object OBJ on the color-depth sensor 1300. Although the imaging lens unit 1200 is shown as a single convex lens, the imaging lens unit 1200 may include a plurality of lenses having different shapes for image formation, aberration correction, and zoom function, among other functions.

The lighting unit 1400 may include a light source for generating and emitting light in the infrared region, such as a laser diode (LD), a light-emitting diode (LED), or a super luminescent diode (SLD). The light source is configured to emit light in the infrared region, e.g., in a wavelength range of 750 nm to 2,500 nm.

The lighting unit 1400 may be configured to emit light modulated with a predetermined frequency toward the object OBJ, and may further include one or more optical elements for adjusting a path or beam shape of the emitted light.

In addition, when the color-depth sensor 1300 has the structure of FIG. 6 including the terahertz sensor 190, the lighting unit 1400 may further include a terahertz generator so as to emit a terahertz beam toward the object OBJ.

The 3D image processor 1500 calculates depth image information about the object OBJ obtained from light sensed by the infrared sensor 150 and combines the calculated depth image information with a color image of the object OBJ obtained from light sensed by the color sensor 130 to create a 3D image.

The depth image information about the object OBJ may be obtained by using a triangulation method or Time-of-Flight (TOF) measurement.

In a triangular method, as a distance of the object OBJ increases, the accuracy of distance information significantly decreases. Thus, it is difficult to obtain accurate distance information. A TOF method has been proposed to obtain accurate distance information. In the TOF method, the time-of-flight of light travelling from a light source to the object OBJ and being reflected from the object OBJ to a light receiver is measured. According to the TOF method, light having a particular wavelength (e.g., 850 nm near-infrared light) is emitted toward an object by an LED or LD, and then light having the same wavelength reflected from the object is received by a light receiver. Then, special processing is performed to extract distance information. TOF methods are classified into various known techniques according to the series of light processing operations used. In a direct time measurement method, a distance to an object is calculated via a timer by measuring the time needed for a pulse of light to travel from a light source to the object and back to the light source after being reflected from the object. In a correlation method, a pulse of light is emitted toward an object from a light source, and a distance from the light source to the object is calculated based on the brightness of light that is reflected from the object. In a phase delay measurement method, continuous wave light such as sine wave light is emitted toward an object from a light source, and a phase difference between the emitted light and light that is reflected off the object is detected and used to calculate a distance from the light source to the object.

For example, the 3D image processor 1500 calculates depth image information about the object OBJ by using one of the above-described methods and combines the depth image information with the color image information to thereby create a 3D image. In processing a depth image, the 3D image processor 1500 may also apply a binning technique and adjust the degree of binning as needed.

In addition, when the color-depth sensor 1300 has the structure of FIG. 6 including the terahertz sensor 190, the 3D image processor 1500 may further perform image processing to create a fluoroscopy image of the object OBJ by using a terahertz wave sensed by the terahertz sensor 190.

FIG. 8 is a schematic block diagram of a 3D image acquisition apparatus 2000 according to another exemplary embodiment.

The 3D image acquisition apparatus 2000 according to the present embodiment includes a lighting unit 2400 that emits terahertz wave and infrared light toward an object OBJ, a complex sensor 2300 having an infrared sensor 150 and a terahertz sensor 190 stacked together to simultaneously sense terahertz wave L_{T} and infrared light Lᵢ, and a 3D image processor 2500 that generates 3D image information by using the terahertz wave L_{T} and the infrared light Lᵢ sensed by the terahertz sensor 190 and the infrared sensor 150, respectively.

The lighting unit 2400 may include a terahertz generator for emitting electromagnetic waves with frequencies between about 100 GHz and about 30 THz, and a light source (not shown) for generating and emitting light in the infrared region, such as an LD, an LED, or a SLD. The terahertz generator and the light source may be separated from each other so as to appropriately illuminate the object OBJ.

The 3D image acquisition apparatus 2000 may further include a bandpass filter 2100 that transmits light in the terahertz region and the infrared region and an imaging lens 2200 that uses light from the object OBJ to form an image on the complex sensor 2300. The 3D image acquisition apparatus 2000 may also include a control unit 2600 that controls operations of the 3D image processor 2500 and the lighting unit 2400, a display unit 2700 that displays a 3D image produced by the 3D image processor 2500, and a memory 2800 that stores 3D image data output from the 3D image processor 2500.

Since terahertz waves have a longer wavelength than visible or infrared rays and also exhibit a high penetration power like X-rays, they can penetrate through an object. On the other hand, the terahertz waves have a lower energy than X-rays and cause no harm to the human body. Furthermore, since when terahertz waves are passing through the object OBJ, particular wavelengths in a terahertz frequency range are absorbed, absorption analysis of the terahertz waves allows extraction of a particular material that X-rays cannot detect.

The 3D image acquisition apparatus 2000 according to the present embodiment employs the complex sensor 2300 including the infrared sensor 150 and the terahertz sensor 190 for detecting terahertz waves having the above-described characteristics to combine a fluoroscopy image of the object OBJ with depth image information to create a 3D image. Furthermore, the 3D image acquisition apparatus 2000 allows analysis of material compositions of the object OBJ.

While exemplary embodiment have been particularly shown and described to, it will be understood that the exemplary embodiments described herein should be considered in a descriptive sense only and not for purposes of limitation, and the scope of the invention is not limited to the specific examples described herein. Furthermore, it will be understood by those of ordinary skill in the art that various changes in form and details may be made to the exemplary embodiments without departing from the spirit and scope of the present invention as defined by the following claims.

1. A color-depth sensor comprising:
a color sensor that senses visible light, and
an infrared sensor that is stacked on the color sensor and senses infrared light.

2. The color-depth sensor of claim 1, wherein the infrared sensor comprises a photoelectric conversion layer comprising of an organic semiconductor material that absorbs infrared light.

3. The color-depth sensor of claim 2, wherein the photoelectric conversion layer comprises at least one of: a layer of a tin phthalocyanine (SnPc): C₆₀ layer, a layer of a mixture of squaraine dye and Phenyl-C61-Butyric-Acid-Methyl-Ester (PCBM), and a layer of a poly_3-hexylthiophene (P3HT):PCBM.

4. The color-depth sensor of claim 2, wherein a thickness of the photoelectric conversion layer creates a resonant cavity structure which resonates infrared light.

5. The color-depth sensor of claim 1, further comprising an infrared cut-off filter that is disposed on an optical path between the infrared sensor and the color sensor, wherein the infrared cut-off filter blocks infrared light.

6. The color-depth sensor of claim 1, further comprising a bandpass filter that is disposed on the infrared sensor, wherein the bandpass filter transmits visible light and infrared light.

7. The color-depth sensor of claim 1, further comprising a terahertz sensor that is disposed on the infrared sensor.

8. A three-dimensional (3D) image acquisition apparatus comprising:
an imaging lens unit;
a color-depth sensor that simultaneously senses color image information and depth image information about an object from light reflected by the object and transmitted through the imaging lens unit; and
a 3D image processor that generates 3D image information using the color image information and the depth image information sensed by the color-depth sensor.

9. The apparatus of claim 8, wherein the color-depth sensor comprises:
a color sensor that senses visible light, and
an infrared sensor that is stacked on the color sensor and senses infrared light.

10. The apparatus of claim 9, wherein the infrared sensor comprises a photoelectric conversion layer comprising of an organic semiconductor material that absorbs infrared light.

11. The apparatus of claim 10, wherein the photoelectric conversion layer comprises at least one of: a layer of a tin phthalocyanine (SnPc): C₆₀ layer, a layer of a mixture of squaraine dye and Phenyl-C61-Butyric-Acid-Methyl-Ester (PCBM), and a layer of a poly_3-hexylthiophene (P3HT):PCBM.

12. The apparatus of claim 8, wherein the color-depth sensor further comprises an infrared cut-off filter that is disposed on an optical path between the infrared sensor and the color sensor, wherein the infrared cut-off filter blocks infrared light.

13. The apparatus of claim 8, wherein the color-depth sensor further comprises a terahertz sensor that is disposed on an optical path toward the infrared sensor.

14. The apparatus of claim 8, further comprising a bandpass filter that transmits infrared light and visible light.

15. The apparatus of claim 14, wherein the bandpass filter is disposed on an optical path between the object and the imaging lens unit.

16. The apparatus of claim 15, wherein the bandpass filter is disposed on a surface of a lens of the imaging lens unit, wherein the surface of the lens faces the object.

17. The apparatus of claim 14, wherein the bandpass filter is disposed on a light entrance surface of the color-depth sensor.

18. The apparatus of claim 8, further comprising a lighting unit that emits light toward the object.

19. The apparatus of claim 18, wherein the lighting unit emits infrared light and comprises one of a light-emitting diode (LED) and a laser diode (LD).

20. A three-dimensional (3D) image acquisition apparatus comprising:
a lighting unit which emits a terahertz wave and infrared light toward an object;
a sensor unit comprising an infrared sensor and a terahertz sensor stacked together with the infrared sensor, wherein the sensor unit simultaneously senses a terahertz wave and infrared light transmitted through or reflected by the object; and
a 3D image processor that generates a terahertz image and a depth image using the terahertz wave and the infrared light sensed by the terahertz sensor and the infrared sensor, respectively, and creates 3D image information using the terahertz image and the depth image.
